(19) United States
(12) Patent Application Publication
(10) Pub. No.: US 2025/0252767 A1
(43) Pub. Date: Aug. 7, 2025

(54) CHARACTER RECOGNITION METHOD AND APPARATUS, ELECTRONIC DEVICE, AND MEDIUM

(71) Applicant: VIVO MOBILE COMMUNICATION CO., LTD., Dongguan (CN)

(72) Inventor: Yan HU, Dongguan (CN)

(73) Assignee: VIVO MOBILE COMMUNICATION CO., LTD., Dongguan (CN)

(21) Appl. No.: 19/186,834

(22) Filed: Apr. 23, 2025

Related U.S. Application Data
(63) Continuation of application No. PCT/CN2023/126280, filed on Oct. 24, 2023.

(30) Foreign Application Priority Data
Oct. 26, 2022 (CN) 202211320472.6

(51) Int. Cl. G06V 30/19; G06V 10/26; G06V 10/77; G06V 10/82; G06V 30/148

(52) U.S. Cl. CPC G06V 30/191; G06V 10/26; G06V 10/7715; G06V 10/82; G06V 30/153

(57) ABSTRACT

This application discloses a character recognition method and apparatus, an electronic device, and a medium. The character recognition method includes: obtaining a character picture, where the character picture includes at least one character; inputting the character picture to a grouped convolutional neural network model for prediction, to obtain character sequence prediction information corresponding to the character picture; and obtaining, based on the character sequence prediction information, a character recognition result corresponding to the character picture.

### CROSS-REFERENCE TO RELATED APPLICATIONS

This application is a continuation of International Application No. PCT/CN2023/126280, filed Oct. 24, 2023, which claims priority to Chinese Patent Application No. 202211320472.6, filed Oct. 26, 2022. The entire contents of each of the above-referenced applications are expressly incorporated herein by reference.

### TECHNICAL FIELD

This application pertains to the field of artificial intelligence technologies, and specifically relates to a character recognition method and apparatus, an electronic device, and a medium.

### BACKGROUND

With development of an intelligent terminal technology, a character recognition technology is increasingly widely used, and the character recognition technology may be used to extract a character from a picture.

In a related technology, when performing character recognition, an electronic device usually directly reduces a quantity of network parameters at each layer of a convolutional neural network model used, to reduce a calculation amount and a quantity of parameters, so as to improve a recognition speed. However, in this method, recognition accuracy of the convolutional neural network model is reduced, and consequently, overall recognition effect is poor.

### SUMMARY

An objective of embodiments of this application is to provide a character recognition method and apparatus, an electronic device, and a medium.

According to a first aspect, an embodiment of this application provides a character recognition method. The method includes: obtaining a character picture, where the character picture includes at least one character; inputting the character picture to a grouped convolutional neural network model for prediction, to obtain character sequence prediction information corresponding to the character picture; and obtaining, based on the character sequence prediction information, a character recognition result corresponding to the character picture.

According to a second aspect, an embodiment of this application provides a character recognition apparatus. The apparatus includes an obtaining module, a prediction module, and a processing module. The obtaining module is configured to obtain a character picture, where the character picture includes at least one character. The prediction module is configured to input the character picture obtained by the obtaining module to a grouped convolutional neural network model for prediction, to obtain character sequence prediction information corresponding to the character picture. The processing module is configured to obtain, based on the character sequence prediction information obtained by the prediction module, a character recognition result corresponding to the character picture.

According to a third aspect, an embodiment of this application provides an electronic device. The electronic device includes a processor and a memory. The memory stores a program or an instruction that can be run on the processor. When the program or the instruction is executed by the processor, the steps of the method according to the first aspect are implemented.

According to a fourth aspect, an embodiment of this application provides a readable storage medium. The readable storage medium stores a program or an instruction. When the program or the instruction is executed by a processor, the steps of the method according to the first aspect are implemented.

According to a fifth aspect, an embodiment of this application provides a chip. The chip includes a processor and a communication interface. The communication interface is coupled to the processor. The processor is configured to run a program or an instruction to implement the method according to the first aspect.

According to a sixth aspect, an embodiment of this application provides a computer program product. The program product is stored in a storage medium. The program product is executed by at least one processor to implement the method according to the first aspect.

According to a seventh aspect, an embodiment of this application provides an electronic device. The electronic device is configured to perform the method according to the first aspect.

### BRIEF DESCRIPTION OF DRAWINGS

FIG. 1 is a schematic flowchart of a character recognition method according to an embodiment of this application;

FIG. 2 is a schematic diagram of a structure of a convolutional recurrent neural network model according to an embodiment of this application;

FIG. 3 is a schematic diagram of a structure of a grouped convolutional neural network model according to an embodiment of this application;

FIG. 4 is a schematic diagram of a structure of a character recognition apparatus according to an embodiment of this application;

FIG. 5 is a schematic diagram of a structure of an electronic device according to an embodiment of this application; and

FIG. 6 is a schematic diagram of hardware of an electronic device according to an embodiment of this application.

### DETAILED DESCRIPTION

The following clearly describes technical solutions in embodiments of this application with reference to accompanying drawings in embodiments of this application. Apparently, the described embodiments are some but not all of embodiments of this application. All other embodiments obtained by a person of ordinary skill based on embodiments of this application shall fall within the protection scope of this application.

In the specification and claims of this application, the terms such as “first” and “second” are used for distinguishing similar objects, and are not necessarily used to describe a particular order or sequence. It should be understood that terms used in such a way are interchangeable in proper circumstances, so that embodiments of this application can be implemented in an order other than the order illustrated or described herein. Objects classified by “first”, “second”, and the like are usually of a same type, and a quantity of objects is not limited. For example, there may be one or more first objects. In addition, in this specification and the claims, “and/or” indicates at least one of connected objects, and a character “/” generally indicates an “or” relationship between associated objects.

With reference to the accompanying drawings, the following describes in detail a character recognition method and apparatus, an electronic device, and a medium provided in embodiments of this application by using specific embodiments and application scenarios thereof.

Currently, a character recognition technology is widely used. Compared with a cloud computing manner, an Optical Character Recognition (OCR) algorithm at a mobile end may complete extraction of a character from a picture in an offline case. This algorithm has significant advantages such as a low delay, data privacy and security protection, reduction in cloud energy consumption, and independence from network stability, and is applicable to scenarios involving considerations of time-effectiveness, costs, and privacy. However, because a calculation resource of an electronic device at the mobile end is limited, a complex OCR algorithm model cannot be run to meet a user requirement for fast and accurate recognition of the character in the picture.

In the OCR algorithm model, a network structure of a Convolutional Recurrent Neural Network (CRNN) temporal classification (Connectionist Temporal Classification, CTC) algorithm is used. The network structure mainly includes three parts: a convolutional neural network, a recurrent neural network, and a transcription neural network. The convolutional neural network is constructed from a series of convolutional layers, pooling layers, and normalization (Batch Normalization, BN) layers. After the picture is input to the convolutional neural network, the picture is converted into a feature map having feature information, and is output in a form of sequence as an input of a recurrent layer. The recurrent neural network includes a Long Short Term Memory (LSTM). The LSTM has a strong information capturing capability for the sequence, and may obtain more context information, to better recognize text information in the picture and obtain a prediction sequence. The transcription neural network converts the prediction sequence obtained by the recurrent neural network into a marker sequence by using a CTC algorithm, to obtain a final recognition result.

In a related technology, when performing character recognition, the electronic device needs to use a model with a small calculation amount. In addition, it is required that good character recognition effect can be implemented. To enable the foregoing CRNN network model to be applied to the electronic device, a quantity of parameters of the convolutional layer in the convolutional neural network in the CRNN network model needs to be reduced, so that a calculation amount of the CRNN network model is reduced, to achieve real-time performance and reduce a volume of the CRNN network model. However, in the foregoing method in which the quantity of parameters is reduced, character recognition accuracy is also significantly reduced. Consequently, final character recognition effect is poor.

In a character recognition method and apparatus, an electronic device, and a medium provided in embodiments of this application, the electronic device may obtain a character picture, where the character picture includes at least one character; input the character picture to a grouped convolutional neural network model for prediction, to obtain character sequence prediction information corresponding to the character picture; and obtain, based on the character sequence prediction information, a character recognition result corresponding to the character picture. In this way, a quantity of parameters of the grouped convolutional neural network model is small. In addition, the grouped convolutional neural network model can divide input data into a plurality of groups, to simultaneously process the plurality of groups of data. Therefore, a calculation amount of the grouped convolutional neural network model can be reduced, and recognition accuracy is ensured, which improves recognition effect of the electronic device.

The character recognition method provided in an embodiment may be performed by the character recognition apparatus. The character recognition apparatus may be an electronic device, or may be a control module or a processing module in the electronic device. The following uses the electronic device as an example to describe the technical solutions provided in embodiments of this application.

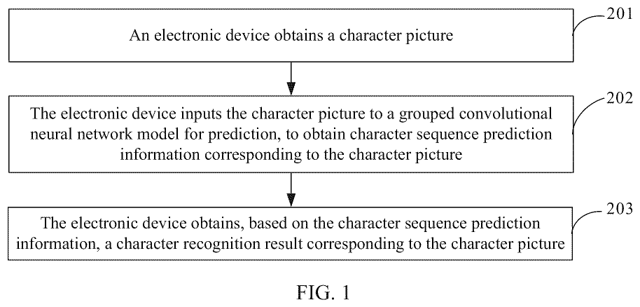

An embodiment of this application provides a character recognition method. As shown in FIG. 1, the character recognition method may include the following steps 201 to 203.

Step 201: An electronic device obtains a character picture.

In some embodiments of this application, the character picture includes at least one character.

For example, the character may be a Chinese character, an English character, or another character. This is not limited in embodiments of this application.

In some embodiments of this application, the character picture may be a character picture obtained through grayscale processing performed by the electronic device.

In some embodiments of this application, the grayscale processing is unified processing performed on values of red (Red, R), green (Green, G), and blue (Blue, B) in the character picture, so that R=G=B.

For example, height sizes of character pictures are equal.

For example, the electronic device may scale sizes of the character pictures, so that the sizes of all the character pictures are adjusted to be equal.

Step 202: The electronic device inputs the character picture to a grouped convolutional neural network model for prediction, to obtain character sequence prediction information corresponding to the character picture.

In some embodiments of this application, the grouped convolutional neural network model includes a group convolutional layer used to extract at least two groups of image feature information corresponding to the character picture.

In some embodiments of this application, the character sequence prediction information is obtained based on the at least two groups of image feature information.

In some embodiments of this application, the grouped convolutional neural network model is improved and generated based on a model of a CRNN+CTC network structure.

For example, a recurrent neural network in a CRNN is removed, to change the model of the CRNN+CTC network structure into a model of a convolutional neural network (CNN) +CTC network structure. Then, a quantity of parameters of each layer in a CNN is reduced, and a part of standard convolutions are replaced with a group convolution that has a same convolution kernel size but fewer parameters and a convolution whose convolution kernel is 1*1. Finally, to compensate for reduction in recognition precision caused by removal of the recurrent neural network and reduction in the quantity of parameters, a network depth of the CNN is increased to improve a representation capability of the grouped convolutional neural network model.

It should be noted that, increasing the network depth of the CNN may mean customizing a convolutional module formed by alternating a group convolution whose convolution kernel is 3*3 and a convolution whose convolution kernel is 1*1 three times.

In some embodiments of this application, the improved model of the CNN+CTC network structure is a prediction model that can be deployed on the electronic device to perform character recognition on the character picture.

For example, sequence positions may be a plurality of probability value prediction positions set by the grouped convolutional neural network model based on a character position order in the character picture.

Step 203: The electronic device obtains, based on the character sequence prediction information, a character recognition result corresponding to the character picture.

In some embodiments of this application, the character sequence prediction information may include a character sequence prediction matrix.

For example, a character sequence is used to indicate the character position order in the character picture.

In some embodiments of this application, that “the electronic device obtains, based on the character sequence prediction information, a character recognition result corresponding to the character picture” in step 203 may include the following step 203a to step 203c.

Step 203a: The electronic device calculates target prediction probability information based on the character sequence prediction information.

In some embodiments of this application, the target prediction probability information is used to represent a probability of each character index corresponding to each sequence position in the character sequence corresponding to the character sequence prediction information.

For example, each character index corresponds to one character in a character library.

In some embodiments of this application, the target prediction probability information may include a character sequence prediction probability matrix.

In some embodiments of this application, the electronic device may perform probability calculation on a character sequence prediction matrix based on a normalized exponential function, to obtain the character sequence prediction probability matrix.

In some embodiments of this application, the normalized exponential function may be a softmax function.

It should be noted that the normalized exponential function is used to uniformly convert values of the character sequence prediction matrix into probability values ranging from 0 to 1.

Step 203b: The electronic device determines a character prediction result at each sequence position based on the target prediction probability information.

In some embodiments of this application, each sequence position may correspond to a plurality of character prediction results. The electronic device may determine that a character prediction result with a maximum prediction probability in the plurality of character prediction results is a character prediction result of the sequence position.

In some embodiments of this application, the electronic device may use prediction information corresponding to a maximum probability value at each sequence position in the character sequence prediction probability as a recognition result index of the sequence position, and then index, from a character set dictionary prestored in the electronic device, a character prediction result corresponding to the prediction information, to obtain a character recognition result at each sequence position.

Step 203c: The electronic device determines, based on the character prediction result at each sequence position, the character recognition result corresponding to the character picture.

In some embodiments of this application, the electronic device may repeat the foregoing indexing step to obtain a character recognition result sequence corresponding to the character sequence. Then, the electronic device may combine repeated recognition results of adjacent sequence positions based on CTC and remove a vacancy recognition result, to obtain the final character recognition result.

The following describes generation of the character set dictionary used in some embodiments of this application.

For example, the electronic device may collect statistics about character frequencies of all Chinese characters that appear during training of the grouped convolutional neural network model, and use Chinese characters whose character frequencies are greater than a preset threshold as the character set dictionary.

In this way, a probability of the character recognition result corresponding to each sequence position is calculated, and a recognition result with a maximum probability is selected from probabilities of a plurality of recognition results to be the final character recognition result, which improves character recognition accuracy.

In the character recognition method provided in some embodiments of this application, the electronic device may obtain the character picture, where the character picture includes the at least one character; input the character picture to the grouped convolutional neural network model for prediction, to obtain the character sequence prediction information corresponding to an image feature in the character picture; and obtain, based on the character sequence prediction information, the character recognition result corresponding to the character picture. In this way, a quantity of parameters of the grouped convolutional neural network model is small. In addition, the grouped convolutional neural network model can divide input data into a plurality of groups, to simultaneously process the plurality of groups of data. Therefore, a calculation amount of the grouped convolutional neural network model can be reduced, and recognition accuracy is ensured, which improves recognition effect of the electronic device.

In some embodiments of this application, the grouped convolutional neural network model includes a first standard convolutional layer, a group convolutional layer, a second standard convolutional layer, and a fully connected layer.

In some embodiments of this application, the first standard convolutional layer, the group convolutional layer, the second standard convolutional layer, and the fully connected layer are connected in sequence.

In some embodiments of this application, the first standard convolutional layer includes a target standard convolution unit, and the first standard convolutional layer includes one convolution kernel.

It should be noted that the target standard convolution unit is used to reduce the quantity of parameters of the grouped convolutional neural network model.

In some embodiments of this application, each convolution in the first standard convolutional layer includes one convolution kernel.

For example, the first standard convolutional layer may be a convolutional layer including a 3*3 convolution, a pooling layer, a 3*3 convolution, a pooling layer, a 1*1 convolution, and a pooling layer.

For example, the target standard convolution unit may be a 1*1 convolution.

It should be noted that the 1*1 convolution is used to prompt that a feature is a size, to avoid an excessively large quantity of parameters of the previous 3*3 convolution.

In some embodiments of this application, the group convolutional layer includes a target group convolution unit, the group convolutional layer includes M convolution kernels, and M is an integer greater than 1.

It should be noted that the target group convolution unit is used to reduce the calculation amount of the grouped convolutional neural network model.

For example, the group convolutional layer may be a group convolutional layer including a 1*1 convolution, a 3*3 group convolution, a 1*1 convolution, a 3*3 group convolution, a 1*1 convolution, a 3*3 group convolution, a 1*1 convolution, and a pooling layer.

For example, the target group convolution unit may be a 3*3 group convolution.

In some embodiments of this application, the second standard convolutional layer includes one convolution kernel.

In this way, the target standard convolution unit and the target group convolution unit are set in the grouped convolutional neural network model, so that the quantity of parameters and the calculation amount of the grouped convolution model can be reduced, and recognition efficiency of the electronic device is improved.

In some embodiments of this application, that the electronic device inputs the character picture to a grouped convolutional neural network model for prediction, to obtain character sequence prediction information corresponding to the character picture in step 202 may include the following step 202a to step 202d.

Step 202a: After inputting the character picture into the grouped convolutional neural network model, the electronic device extracts first image feature information of the character picture by using the first standard convolutional layer.

In some embodiments of this application, the first image feature information is used to represent a character area feature in the character picture.

For example, the electronic device may extract a primary feature (namely, the first image feature information) from the character picture by using the 3*3 convolution, the pooling layer, the 3*3 convolution, the pooling layer, the 1*1 convolution, the pooling layer in sequence (that is, by using the first standard convolutional layer).

Step 202b: The electronic device groups the first image feature information by using the group convolutional layer to obtain M groups of image feature information, extracts key image feature information in the M groups of image feature information by using M convolution kernels in the group convolutional layer respectively, and fuses obtained M groups of key image feature information to obtain first key image feature information.

In some embodiments of this application, each convolution kernel in the group convolutional layer is used to process one group of image feature information.

In some embodiments of this application, the first key image feature information is used to represent character feature information in the character area feature.

For example, the electronic device may extract an intermediate feature from the primary feature by using the 1*1 convolution, the group convolution, the 1*1 convolution, the group convolution, the 1*1 convolution, the group convolution, the 1*1 convolution, and the pooling layer in sequence (that is, by using the group convolutional layer). The 1*1 convolution is used to process an irregular result output by a previous pooling layer, to improve a network expression capability. Then, an advanced feature (namely, the first key image feature information) is extracted from the intermediate feature by using the 1*1 convolution, the group convolution, the 1*1 convolution, the group convolution, the 1*1 convolution, the group convolution, the 1*1 convolution, and the pooling layer in sequence. The group convolution is a group convolution that is divided into 4 groups and whose convolution kernel size is 3*3. The group convolution may evenly divide the first image feature information into four groups, and each group uses a 3*3 convolution kernel to perform convolutional calculation to obtain key image feature information of the group. Then, four groups of key image feature information are combined to obtain one convolutional output (namely, the first key image feature information).

It should be noted that a quantity of parameters of the group convolution whose convolution kernel is 3*3 is only one-fourth of a quantity of parameters of a convolution whose convolution kernel is 3*3.

Step 202c: The electronic device extracts a character sequence feature of the first key image feature information by using the second standard convolutional layer.

In some embodiments of this application, the character sequence feature is used to represent character content of the character in the character picture.

For example, after obtaining the first key image feature information, the electronic device may first process irregular information in the first key image feature information by using a 1*1 convolution, and then convert a height dimension size of processed first key image feature information into 1 (that is, remove a height dimension) by using a 2*2 convolution (namely, the second standard convolutional layer), to extract the character sequence feature from first key image feature information whose height dimension is removed.

Step 202d: The electronic device obtains, by using the fully connected layer, character sequence prediction information corresponding to the character sequence feature.

In a related technology, after the character sequence feature is obtained, two LSTMs are used to extract the sequence feature, and the character sequence feature is converted into the character sequence prediction matrix. However, the LSTM cannot perform parallel processing, and processing efficiency of the LSTM applied to the electronic device is low. Consequently, character recognition effect is poor.

In some embodiments of this application, after obtaining the character sequence feature, the electronic device may reduce a feature dimension size of the character sequence feature by using one fully connected layer, to reduce a quantity of parameters of a next fully connected layer. Then, the character sequence feature is converted into the character sequence prediction matrix (namely, the character sequence prediction information) by using one fully connected layer.

It should be noted that the feature dimension size is equal to a quantity of characters in the character set dictionary plus 1.

It may be understood that the electronic device may add an empty character on the basis of the quantity of all the characters included in the character set dictionary, and then set the feature dimension size based on a quantity of characters obtained after adding of the empty character, so that the feature dimension size is equal to the quantity of characters obtained after adding of the empty character.

In this way, the input character picture is processed by using the improved grouped convolutional neural network model, so that the electronic device can obtain the corresponding character sequence prediction information more quickly. In addition, the first key image feature information is processed by using the fully connected layer, which further reduces the quantity of parameters of the grouped convolutional neural network model, and improves recognition effect of the electronic device on character recognition.

In some embodiments of this application, after step 201, the character recognition method provided in some embodiments of this application further includes the following step 201a:

Step 201a: The electronic device crops the character picture into N character sub-pictures.

In some embodiments of this application, each character sub-picture in the N character sub-pictures includes at least one character, and N is an integer greater than 1.

In some embodiments of this application, picture height sizes of the N character sub-pictures are equal.

In some embodiments of this application, the electronic device may detect all text line positions in the character picture, then obtain, through cropping, all text line pictures (namely, the N character sub-pictures) based on detected position coordinates, and scale the text line pictures to pictures with equal heights.

It should be noted that the height of the text line picture matches a data size that can be processed by the grouped convolutional neural network model.

Further, in some embodiments of this application, with reference to step 201a, that the electronic device inputs the character picture to a grouped convolutional neural network model for prediction, to obtain character sequence prediction information corresponding to the character picture in step 202 may include the following step 202e:

Step 202e: The electronic device inputs the N character sub-pictures to the grouped convolutional neural network model for prediction, to obtain character sequence prediction information corresponding to each character sub-picture in the N character sub-pictures.

In some embodiments of this application, the electronic device may input a 1^{st} character sub-picture in the N character sub-pictures into the grouped convolutional neural network model for prediction, and after obtaining a prediction result, input a 2^{nd} character sub-picture for prediction in sequence.

In some embodiments of this application, after obtaining the character sequence prediction information corresponding to each character sub-picture in the N character sub-pictures, the electronic device may obtain character recognition results based on the prediction information. Then, the character recognition results are typeset based on the detected text position coordinates, to obtain a target character recognition result of the character picture.

In this way, the character picture is cropped and processed in sequence, so that the calculation amount of the grouped convolutional neural network model is smaller, a recognition speed is further improved, and recognition precision is ensured.

The following describes an example of a training process of the grouped convolutional neural network model used in some embodiments of this application.

For example, the training process of the grouped convolutional neural network model may include the following steps S1 to S4.

### Step S1: Data Collection and Expansion

In some embodiments of this application, when data is collected, to enable the grouped convolutional neural network model to be commonly used in various scenarios, collected character pictures also need to include a plurality of scenarios (such as a card, a book, a newspaper, a screenshot, a screen, a poster, a street view, and a handwritten character) and the like to a greatest extent. Then, a corresponding character label file needs to be obtained for the collected character picture through manual labeling.

Because efficiency of manually collecting and labeling the data is excessively low, the data needs to be expanded through data synthesis. There are two manners of data expansion: data augmentation and font synthesis.

Data augmentation means processing labeled real data into new data through random geometric deformation, fuzzy processing, brightness and contrast adjustment, image compression, and the like.

Font synthesis means drawing a character picture by using a font file and a corpus, and increasing reality and diversity of a synthesized picture through a random background, a character color, a font, geometric deformation, a perspective change, fuzzy processing, brightness and contrast adjustment, image compression, and the like.

In some embodiments of this application, sufficient training data may be obtained by using the three methods: real collection, data augmentation, and font synthesis.

### Step S2: Data Preprocessing

In some embodiments of this application, before the collected data is sent to a model for training, unified processing needs to be performed on the data, which is specifically size scaling, width sorting, and dictionary creation.

Size scaling: Design of the model requires that a height of an input character picture is fixed at 32 and a width is not fixed. Therefore, the data needs to be uniformly scaled to a size with the height of 32 in an equal ratio.

Width sorting: Character pictures are characterized by different lengths. When training is performed, a plurality of character pictures are usually inputted in batches. This requires that character pictures in a batch are the same in width and height. When character pictures in a same batch have significant difference in widths, forcibly adjusting the widths to be consistent will lead to distortion of characters in some character pictures, which results in a large loss of information and makes it difficult to achieve good training effect. Therefore, character pictures in a training set may be sorted based on a length-to-width ratio. Several character pictures with close length-to-width ratios are used as a same batch, and all character pictures in the batch are uniformly scaled based on a size of a character picture with a smallest width in the batch.

Step S3: model establishment.

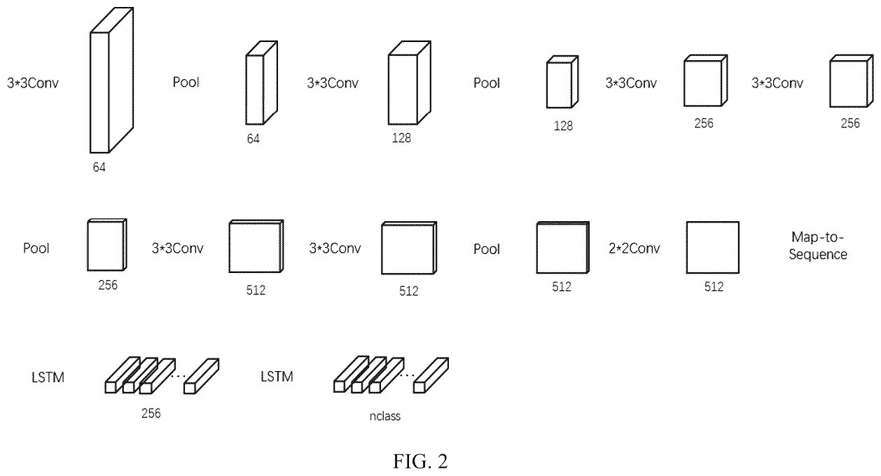

In some embodiments of this application, as shown in FIG. 2, a classical CRNN network structure includes a CNN based on a 3*3 convolution and a Recurrent Neural Network (RNN) based on a LSTM. After inputting a character picture whose height is 32 into the model, an electronic device first extracts image feature information by using a

CNN. For example, one 3*3 convolution (3*3 Conv), a pooling layer (pool), one 3*3 convolution, a pooling layer, two 3*3 convolutions, a pooling layer, two 3*3 convolutions, and a pooling layer are used in sequence to extract the image feature information, and feature dimension sizes are gradually increased from 64 to 512. Then, a sequence feature is generated by using an image-to-sequence mapping structure (Map-to-Sequence). Then, the sequence feature in the image feature information is extracted by using two LSTMs, and the sequence feature is converted into a sequence prediction matrix for output.

It should be noted that the CNN mainly includes pooling layers and convolutions whose feature dimension sizes are gradually increased and whose convolution kernels are 3*3, and is used to extract the image feature information. The RNN includes two layers of LSTMs, and is used to extract the sequence feature, and convert the sequence feature into the sequence prediction matrix. However, a calculation amount of the CRNN network structure is excessively large, and neither performance nor a model volume can meet a requirement of an electronic device side. In addition, this is not conducive to deploying the LSTM on the electronic device side.

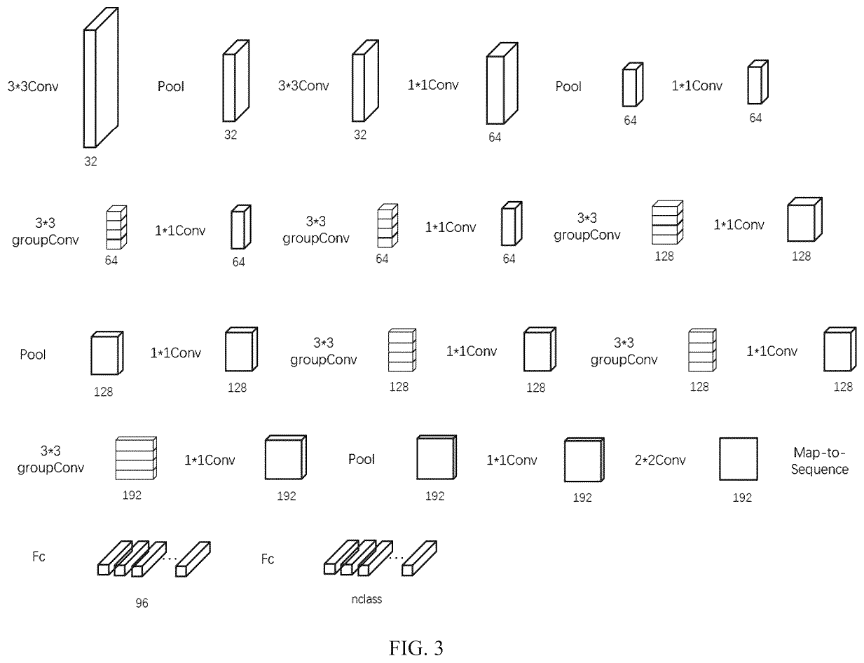

In some embodiments of this application, to enable the model to have good performance and effect on an electronic device side with a small calculation capability, as shown in FIG. 3, the feature dimension sizes are greatly reduced. In addition, the LSTM that is not easily deployed on the electronic device side is removed, and fully connected layers (Fully Connected layers, FC) are used to convert the sequence feature into the sequence prediction matrix. In addition, only the CNN network is used instead of a CNN+RNN network to extract the image feature information. In addition, the CNN network discards the original solution in which the convolutions with only 3*3 convolution kernels are used. Instead, a part of the convolutions with 3*3 convolution kernels are replaced with a group convolution with a small quantity of parameters and a 1*1 convolution, and a model feature learning capability is improved by using a large quantity of network layers.

For example, to reduce a quantity of parameters and ensure a good feature learning capability, the feature dimension sizes are reduced to be gradually increased from 32 to 192. Then, a 3*3 convolution, a pooling layer, a 3*3 convolution, a 1*1 convolution (1*1 Conv), and a pooling layer are used in sequence to extract primary image feature information from the input character picture, where the added 1*1 convolution is used to improve the feature dimension size, so as to avoid an excessively large quantity of parameters of a previous 3*3 convolution. Then, intermediate image feature information is extracted from the primary image feature information by using a 1*1 convolution, a group convolution (3*3 group Conv), a 1*1 convolution, a group convolution, a 1*1 convolution, a group convolution, a 1*1 convolution, and a pooling layer in sequence, where the 1^{st} 1*1convolution is used to add a nonlinear excitation to an output of the previous pooling layer, so as to improve a network expression capability. Then, advanced image feature information is extracted from the intermediate image feature information in a processing manner of a 1*1 convolution, a group convolution, a 1*1 convolution, a group convolution, a 1*1 convolution, a group convolution, a 1*1 convolution, and a pooling layer again. Finally, a nonlinear excitation is added to the advanced image feature information by using a 1*1 convolution, a height dimension size is converted to 1 by using a 2*2 convolution, a height dimension is removed, and a feature dimension and a width dimension are exchanged, to meet a requirement of being input to a next layer, and convert the four-dimensional advanced image feature information into a three-dimensional sequence feature. Then, a feature dimension size of the sequence feature is reduced by using a fully connected layer with a small quantity of parameters, to reduce a quantity of parameters of the next layer, and then the sequence feature with a reduced feature dimension size is converted into the sequence prediction matrix by using a fully connected layer. The obtained sequence prediction matrix is an output result of the entire model.

It should be noted that, compared with a structure of the two 3*3 convolutions in a conventional CRNN, a combination of the group convolution and the 1*1 convolution that are alternately repeated three times enhances a network depth while reducing the quantity of parameters, so that a model representation capability is improved.

Step S4: model training and quantization.

In some embodiments of this application, model training is as follows: Trained character pictures are divided into a plurality of batches, and each batch includes a fixed quantity of character pictures. Then, the character pictures are randomly sent to the model in batches. After a batch of character pictures are sent to the model, a character sequence prediction matrix is obtained through layer-by-layer calculation by using the model established in step S3, and then a normalized exponential function (softmax) is used to convert values in the character sequence prediction matrix into a character sequence prediction probability matrix whose value range is 0 to 1. Then, a result corresponding to a maximum probability value is used as a prediction result of a sequence position based on the character sequence prediction probability matrix and a greedy algorithm, and a predicted character sequence is obtained through mapping based on indexes of the foregoing character set dictionary. A classical loss function (CTC loss) is used to calculate a loss value between the predicted character sequence and a corresponding label character sequence in the character picture, and a stochastic optimizer (Adaptive momentum, Adam) is used to propagate the model backwards based on the loss value, to update model parameters. An initial learning rate of the stochastic optimizer is set to 0.0005, and then is gradually decreased in a cosine learning rate decrease manner. Then, the foregoing operations are repeated on a next batch of character pictures to update the model parameters again. After a plurality of rounds of parameter update, the loss value falls into a proper range and tends to be stable, so that training of the model is completed.

Model quantization: To accelerate a model inference speed and maintain good precision, parameters are stored and the model is inferred by using half-precision floating-point (FP) 16, to obtain the grouped convolutional neural network model.

The character recognition method provided in an embodiment of this application may be performed by a character recognition apparatus. In an embodiment of this application, a character recognition apparatus provided in some embodiments of this application is described by using an example in which the character recognition method is performed by the character recognition apparatus.

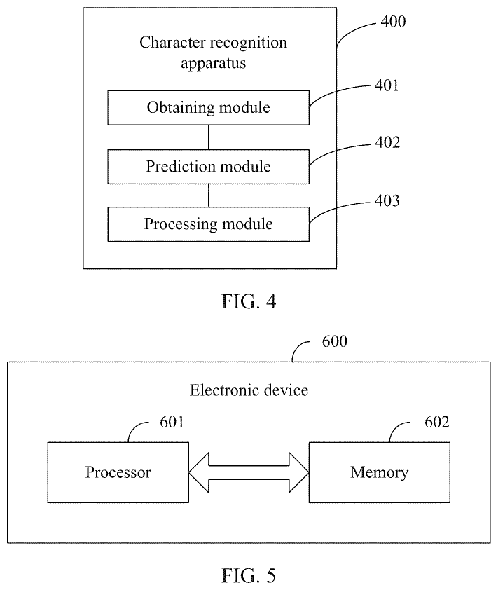

An embodiment of this application provides a character recognition apparatus. As shown in FIG. 4, the character recognition apparatus 400 includes an obtaining module 401, a prediction module 402, and a processing module 403. The obtaining module 401 is configured to obtain a character picture, where the character picture includes at least one character. The prediction module 402 is configured to input the character picture obtained by the obtaining module 401 to a grouped convolutional neural network model for prediction, to obtain character sequence prediction information corresponding to the character picture. The processing module 403 is configured to obtain, based on the character sequence prediction information obtained by the prediction module 402, a character recognition result corresponding to the character picture.

In some embodiments of this application, the grouped convolutional neural network model includes a first standard convolutional layer, a group convolutional layer, a second standard convolutional layer, and a fully connected layer. The prediction module 402 is configured to: after inputting the character picture obtained by the obtaining module 401 to the grouped convolutional neural network model, extract first image feature information of the character picture by using the first standard convolutional layer; group the first image feature information by using the group convolutional layer to obtain M groups of image feature information, extract key image feature information in the M groups of image feature information by using M convolution kernels in the group convolutional layer respectively, and fuse obtained M groups of key image feature information to obtain first key image feature information, where each convolution kernel in the group convolutional layer is used to process one group of image feature information, and M is an integer greater than 1; extract a character sequence feature of the first key image feature information by using the second standard convolutional layer; and obtain, by using the fully connected layer, character sequence prediction information corresponding to the character sequence feature.

In some embodiments of this application, the first standard convolutional layer, the group convolutional layer, the second standard convolutional layer, and the fully connected layer are connected in sequence. The first standard convolutional layer includes a target standard convolution unit, the target standard convolution unit is used to reduce a quantity of parameters of the grouped convolutional neural network model, and the first standard convolutional layer includes one convolution kernel. The group convolutional layer includes a target group convolution unit, the target group convolution unit is used to reduce a calculation amount of the grouped convolutional neural network model, and the group convolutional layer includes M convolution kernels. The second standard convolutional layer includes one convolution kernel.

In some embodiments of this application, the character recognition apparatus 400 further includes a cropping module. The cropping module is configured to: after the obtaining module 401 obtains the character picture, crop the character picture into N character sub-pictures, where each character sub-picture includes at least one character, and N is an integer greater than 1. The prediction module 402 is configured to input the N character sub-pictures obtained by the cropping module to the grouped convolutional neural network model for prediction, to obtain character sequence prediction information corresponding to each character sub-picture in the N character sub-pictures.

In some embodiments of this application, the processing module 403 is configured to: calculate target prediction probability information based on the character sequence prediction information obtained by the prediction module 402, where the target prediction probability information is used to represent a probability of each character index corresponding to each sequence position in a character sequence corresponding to the character sequence prediction information, and each character index corresponds to one character in a character library; determine a character prediction result at each sequence position based on the target prediction probability information; and determine, based on the character prediction result at each sequence position, a character recognition result corresponding to the character picture.

In the character recognition apparatus provided in some embodiments of this application, the character recognition apparatus may obtain the character picture, where the character picture includes the at least one character; input the character picture to the grouped convolutional neural network model for prediction, to obtain the character sequence prediction information corresponding to the character picture; and obtain, based on the character sequence prediction information, the character recognition result corresponding to the character picture. In this way, a quantity of parameters of the grouped convolutional neural network model is small. In addition, the grouped convolutional neural network model can divide input data into a plurality of groups, to simultaneously process the plurality of groups of data. Therefore, a calculation amount of the grouped convolutional neural network model can be reduced, and recognition accuracy is ensured, which improves recognition effect of the character recognition apparatus.

The character recognition apparatus in some embodiments of this application may be an electronic device, or may be a component in the electronic device, such as an integrated circuit or a chip. The electronic device may be a terminal, or another device other than the terminal. For example, the electronic device may be a mobile phone, a tablet computer, a notebook computer, a palmtop computer, an in-vehicle electronic device, a Mobile Internet Device (MID), an augmented reality (AR)/virtual reality (VR) device, a robot, a wearable device, an ultra-mobile personal computer (UMPC), a netbook, a personal digital assistant (PDA), or the like, or may be a server, a network attached storage (NAS), a personal computer (PC), a television (TV), a teller machine, a self-service machine, or the like. This is not specifically limited in embodiments of this application.

The character recognition apparatus in some embodiments of this application may be an apparatus having an operating system. The operating system may be an Android operating system, an iOS operating system, or another possible operating system. This is not specifically limited in some embodiments of this application.

The character recognition apparatus provided in some embodiments of this application can implement processes implemented in the method embodiment of FIG. 1. To avoid repetition, details are not described herein again.

As shown in FIG. 5, an embodiment of this application further provides an electronic device 600, including a processor 601 and a memory 602. The memory 602 stores a program or an instruction that can be run on the processor 601. When the program or the instruction is executed by the processor 601, steps in the foregoing character recognition method embodiment can be implemented, and the same technical effect can be achieved. To avoid repetition, details are not described herein again.

It should be noted that the electronic device in some embodiments of this application includes the foregoing mobile electronic device and non-mobile electronic device.

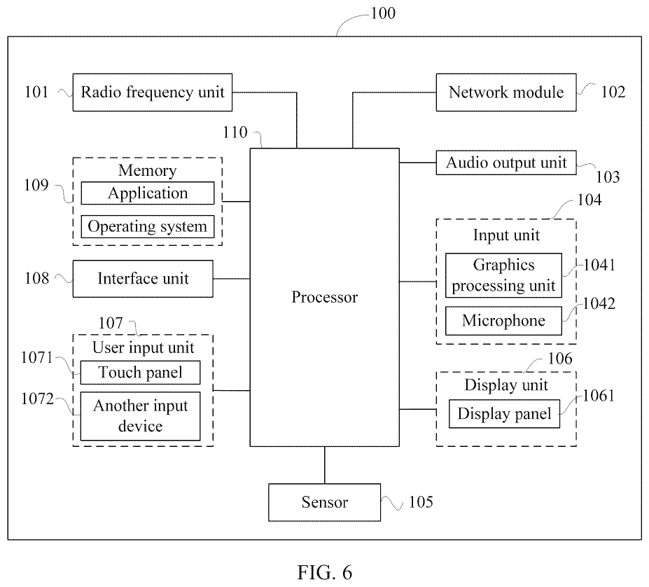

FIG. 6 is a schematic diagram of a hardware structure of an electronic device according to an embodiment of this application.

The electronic device 100 includes but is not limited to components such as a radio frequency unit 101, a network module 102, an audio output unit 103, an input unit 104, a sensor 105, a display unit 106, a user input unit 107, an interface unit 108, a memory 109, and a processor 110.

A person skilled in the art can understand that the electronic device 100 may further include a power supply (for example, a battery) that supplies power to each component. The power supply may be logically connected to the processor 110 by using a power supply management system, so as to manage functions such as charging, discharging, and power consumption by using the power supply management system. The structure of the electronic device shown in FIG. 6 does not constitute a limitation on the electronic device, and the electronic device may include more or fewer components than those shown in the figure, or combine some components, or have different component arrangements. Details are not described herein again.

The processor 110 is configured to: obtain a character picture, where the character picture includes at least one character; input the character picture to a grouped convolutional neural network model for prediction, to obtain character sequence prediction information corresponding to the character picture; and obtain, based on the character sequence prediction information, a character recognition result corresponding to the character picture.

In some embodiments of this application, the grouped convolutional neural network model includes a first standard convolutional layer, a group convolutional layer, a second standard convolutional layer, and a fully connected layer. The processor 110 is configured to: after inputting the character picture to the grouped convolutional neural network model, extract first image feature information of the character picture by using the first standard convolutional layer; group the first image feature information by using the group convolutional layer to obtain M groups of image feature information, extract key image feature information in the M groups of image feature information by using M convolution kernels in the group convolutional layer respectively, and fuse obtained M groups of key image feature information to obtain first key image feature information, where each convolution kernel in the group convolutional layer is used to process one group of image feature information, and M is an integer greater than 1; extract a character sequence feature of the first key image feature information by using the second standard convolutional layer; and obtain, by using the fully connected layer, character sequence prediction information corresponding to the character sequence feature.

In some embodiments of this application, the first standard convolutional layer, the group convolutional layer, the second standard convolutional layer, and the fully connected layer are connected in sequence. The first standard convolutional layer includes a target standard convolution unit, the target standard convolution unit is used to reduce a quantity of parameters of the grouped convolutional neural network model, and the first standard convolutional layer includes one convolution kernel. The group convolutional layer includes a target group convolution unit, the target group convolution unit is used to reduce a calculation amount of the grouped convolutional neural network model, and the group convolutional layer includes M convolution kernels. The second standard convolutional layer includes one convolution kernel.

In some embodiments of this application, the processor 110 is further configured to crop the character picture into N character sub-pictures, where each character sub-picture includes at least one character, and N is an integer greater than 1. The processor 110 is configured to input the N character sub-pictures to the grouped convolutional neural network model for prediction, to obtain character sequence prediction information corresponding to each character sub-picture in the N character sub-pictures.

In some embodiments of this application, the processor 110 is configured to: calculate target prediction probability information based on the character sequence prediction information obtained by the prediction module 402, where the target prediction probability information is used to represent a probability of each character index corresponding to each sequence position in a character sequence corresponding to the character sequence prediction information, and each character index corresponds to one character in a character library; determine a character prediction result at each sequence position based on the target prediction probability information; and determine, based on the character prediction result at each sequence position, a character recognition result corresponding to the character picture.

In the electronic device provided in some embodiments of this application, the electronic device may obtain the character picture, where the character picture includes the at least one character; input the character picture to the grouped convolutional neural network model for prediction, to obtain the character sequence prediction information corresponding to the character picture; and obtain, based on the character sequence prediction information, the character recognition result corresponding to the character picture. In this way, a quantity of parameters of the grouped convolutional neural network model is small. In addition, the grouped convolutional neural network model can divide input data into a plurality of groups, to simultaneously process the plurality of groups of data. Therefore, a calculation amount of the grouped convolutional neural network model can be reduced, and recognition accuracy is ensured, which improves recognition effect of the electronic device.

It should be understood that in some embodiments of this application, the input unit 104 may include a Graphics Processing Unit (GPU) 1041 and a microphone 1042. The graphics processing unit 1041 processes image data of a static picture or a video obtained by an image capture apparatus (for example, a camera) in a video capture mode or an image capture mode. The display unit 106 may include a display panel 1061, and the display panel 1061 may be configured in a form of liquid crystal display, organic light-emitting diode, or the like. The user input unit 107 includes at least one of a touch panel 1071 or another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

The memory 109 may be configured to store a software program and various data. The memory 109 may mainly include a first storage area for storing a program or an instruction and a second storage area for storing data. The first storage area may store an operating system, an application or an instruction required by at least one function (for example, a sound playing function or an image playing function), and the like. In addition, the memory 109 may include a volatile memory or a non-volatile memory, or the memory 109 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 109 in some embodiments of this application includes but is not limited to these memories and any memory of another proper type.

The processor 110 may include one or more processing units. In some embodiments, an application processor and a modem processor are integrated into the processor 110. The application processor mainly processes operations related to an operating system, a user interface, an application, and the like. The modem processor mainly processes a wireless communication signal, for example, a baseband processor. It may be understood that, in some embodiments, the modem processor may not be integrated into the processor 110.

An embodiment of this application further provides a readable storage medium. The readable storage medium stores a program or an instruction. When the program or the instruction is executed by a processor, processes in the foregoing character recognition method embodiment are implemented, and the same technical effect can be achieved. To avoid repetition, details are not described herein again.

The processor is a processor in the electronic device in the foregoing embodiment. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or an instruction to implement processes of the foregoing character recognition method embodiment, and the same technical effect can be achieved. To avoid repetition, details are not described herein again.

It should be understood that the chip mentioned in some embodiments of this application may also be referred to as a system-level chip, a system chip, a chip system, or an on-chip system chip.

An embodiment of this application provides a computer program product. The program product is stored in a storage medium. The program product is executed by at least one processor to implement processes in the foregoing character recognition method embodiment, and the same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in embodiments of this application is not limited to performing functions in an illustrated or discussed order, and may further include performing functions in a basically simultaneous manner or in a reverse order according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, a network device, or the like) to perform the methods described in embodiments of this application.

Embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A method for character recognition, comprising:
obtaining a character picture, wherein the character picture comprises at least one character;
inputting the character picture to a grouped convolutional neural network model for prediction, to obtain character sequence prediction information corresponding to the character picture; and
obtaining, based on the character sequence prediction information, a character recognition result corresponding to the character picture.

2. The method according to claim 1, wherein the grouped convolutional neural network model comprises a first standard convolutional layer, a group convolutional layer, a second standard convolutional layer, and a fully connected layer; and
the inputting the character picture to a grouped convolutional neural network model for prediction, to obtain character sequence prediction information corresponding to the character picture comprises:
after the character picture is input to the grouped convolutional neural network model, extracting first image feature information of the character picture by using the first standard convolutional layer;
grouping the first image feature information by using the group convolutional layer to obtain M groups of image feature information, extracting key image feature information in the M groups of image feature information by using M convolution kernels in the group convolutional layer respectively, and fusing obtained M groups of key image feature information to obtain first key image feature information, wherein each convolution kernel in the group convolutional layer is used to process one group of image feature information, and M is an integer greater than 1;
extracting a character sequence feature of the first key image feature information by using the second standard convolutional layer; and
obtaining, by using the fully connected layer, character sequence prediction information corresponding to the character sequence feature.

3. The method according to claim 2, wherein:
the first standard convolutional layer, the group convolutional layer, the second standard convolutional layer, and the fully connected layer are connected in sequence;
the first standard convolutional layer comprises a target standard convolution unit, the target standard convolution unit is used to reduce a quantity of parameters of the grouped convolutional neural network model, and the first standard convolutional layer comprises one convolution kernel;
the group convolutional layer comprises a target group convolution unit, the target group convolution unit is used to reduce a calculation amount of the grouped convolutional neural network model, and the group convolutional layer comprises M convolution kernels; and
the second standard convolutional layer comprises one convolution kernel.

4. The method according to claim 1, wherein after the obtaining a character picture, the method further comprises:
cropping the character picture into N character sub-pictures, wherein each character sub-picture comprises at least one character, and N is an integer greater than 1; and
the inputting the character picture to a grouped convolutional neural network model for prediction, to obtain character sequence prediction information corresponding to the character picture comprises:
inputting the N character sub-pictures to the grouped convolutional neural network model for prediction, to obtain character sequence prediction information corresponding to each character sub-picture in the N character sub-pictures.

5. The method according to claim 1, wherein the obtaining, based on the character sequence prediction information, a character recognition result corresponding to the character picture comprises:
calculating target prediction probability information based on the character sequence prediction information, wherein the target prediction probability information is used to represent a probability of each character index corresponding to each sequence position in a character sequence corresponding to the character sequence prediction information, and each character index corresponds to one character in a character library;
determining a character prediction result at each sequence position based on the target prediction probability information; and
determining, based on the character prediction result at each sequence position, a character recognition result corresponding to the character picture.

6. An electronic device, comprising a processor and a memory storing a program or an instruction that is capable of running on the processor, wherein the program or the instruction, when executed by the processor, causes the electronic device to perform:
obtaining a character picture, wherein the character picture comprises at least one character;
inputting the character picture to a grouped convolutional neural network model for prediction, to obtain character sequence prediction information corresponding to the character picture; and
obtaining, based on the character sequence prediction information, a character recognition result corresponding to the character picture.

7. The electronic device according to claim 6, wherein the grouped convolutional neural network model comprises a first standard convolutional layer, a group convolutional layer, a second standard convolutional layer, and a fully connected layer; and
the inputting the character picture to a grouped convolutional neural network model for prediction, to obtain character sequence prediction information corresponding to the character picture comprises:
after the character picture is input to the grouped convolutional neural network model, extracting first image feature information of the character picture by using the first standard convolutional layer;
grouping the first image feature information by using the group convolutional layer to obtain M groups of image feature information, extracting key image feature information in the M groups of image feature information by using M convolution kernels in the group convolutional layer respectively, and fusing obtained M groups of key image feature information to obtain first key image feature information, wherein each convolution kernel in the group convolutional layer is used to process one group of image feature information, and M is an integer greater than 1;
extracting a character sequence feature of the first key image feature information by using the second standard convolutional layer; and
obtaining, by using the fully connected layer, character sequence prediction information corresponding to the character sequence feature.

8. The electronic device according to claim 7, wherein:
the first standard convolutional layer, the group convolutional layer, the second standard convolutional layer, and the fully connected layer are connected in sequence;
the first standard convolutional layer comprises a target standard convolution unit, the target standard convolution unit is used to reduce a quantity of parameters of the grouped convolutional neural network model, and the first standard convolutional layer comprises one convolution kernel;
the group convolutional layer comprises a target group convolution unit, the target group convolution unit is used to reduce a calculation amount of the grouped convolutional neural network model, and the group convolutional layer comprises M convolution kernels; and
the second standard convolutional layer comprises one convolution kernel.

9. The electronic device according to claim 6, wherein after the obtaining a character picture, the method further comprises:
cropping the character picture into N character sub-pictures, wherein each character sub-picture comprises at least one character, and N is an integer greater than 1; and
the inputting the character picture to a grouped convolutional neural network model for prediction, to obtain character sequence prediction information corresponding to the character picture comprises:
inputting the N character sub-pictures to the grouped convolutional neural network model for prediction, to obtain character sequence prediction information corresponding to each character sub-picture in the N character sub-pictures.

10. The electronic device according to claim 6, wherein the obtaining, based on the character sequence prediction information, a character recognition result corresponding to the character picture comprises:
calculating target prediction probability information based on the character sequence prediction information, wherein the target prediction probability information is used to represent a probability of each character index corresponding to each sequence position in a character sequence corresponding to the character sequence prediction information, and each character index corresponds to one character in a character library;
determining a character prediction result at each sequence position based on the target prediction probability information; and
determining, based on the character prediction result at each sequence position, a character recognition result corresponding to the character picture.

11. A non-transitory computer-readable storage medium storing a program or an instruction, wherein the program or the instruction, when executed by a processor, causes the processor to perform:
obtaining a character picture, wherein the character picture comprises at least one character;
inputting the character picture to a grouped convolutional neural network model for prediction, to obtain character sequence prediction information corresponding to the character picture; and
obtaining, based on the character sequence prediction information, a character recognition result corresponding to the character picture.

12. The non-transitory computer-readable storage medium according to claim 11, wherein the grouped convolutional neural network model comprises a first standard convolutional layer, a group convolutional layer, a second standard convolutional layer, and a fully connected layer; and
the inputting the character picture to a grouped convolutional neural network model for prediction, to obtain character sequence prediction information corresponding to the character picture comprises:
after the character picture is input to the grouped convolutional neural network model, extracting first image feature information of the character picture by using the first standard convolutional layer;
grouping the first image feature information by using the group convolutional layer to obtain M groups of image feature information, extracting key image feature information in the M groups of image feature information by using M convolution kernels in the group convolutional layer respectively, and fusing obtained M groups of key image feature information to obtain first key image feature information, wherein each convolution kernel in the group convolutional layer is used to process one group of image feature information, and M is an integer greater than 1;
extracting a character sequence feature of the first key image feature information by using the second standard convolutional layer; and
obtaining, by using the fully connected layer, character sequence prediction information corresponding to the character sequence feature.

13. The non-transitory computer-readable storage medium according to claim 12, wherein:
the first standard convolutional layer, the group convolutional layer, the second standard convolutional layer, and the fully connected layer are connected in sequence;
the first standard convolutional layer comprises a target standard convolution unit, the target standard convolution unit is used to reduce a quantity of parameters of the grouped convolutional neural network model, and the first standard convolutional layer comprises one convolution kernel;
the group convolutional layer comprises a target group convolution unit, the target group convolution unit is used to reduce a calculation amount of the grouped convolutional neural network model, and the group convolutional layer comprises M convolution kernels; and
the second standard convolutional layer comprises one convolution kernel.

14. The non-transitory computer-readable storage medium according to claim 11, wherein after the obtaining a character picture, the method further comprises:
cropping the character picture into N character sub-pictures, wherein each character sub-picture comprises at least one character, and N is an integer greater than 1; and
the inputting the character picture to a grouped convolutional neural network model for prediction, to obtain character sequence prediction information corresponding to the character picture comprises:
inputting the N character sub-pictures to the grouped convolutional neural network model for prediction, to obtain character sequence prediction information corresponding to each character sub-picture in the N character sub-pictures.

15. The non-transitory computer-readable storage medium according to claim 11, wherein the obtaining, based on the character sequence prediction information, a character recognition result corresponding to the character picture comprises:
calculating target prediction probability information based on the character sequence prediction information, wherein the target prediction probability information is used to represent a probability of each character index corresponding to each sequence position in a character sequence corresponding to the character sequence prediction information, and each character index corresponds to one character in a character library;
determining a character prediction result at each sequence position based on the target prediction probability information; and
determining, based on the character prediction result at each sequence position, a character recognition result corresponding to the character picture.
